(19) United States
(12) Patent Application Publication
(10) Pub. No.: US 2026/0279070 A1
(43) Pub. Date: Sep. 17, 2026

(54) METHOD AND APPARATUS FOR DETERMINING PERCEPTION RESULT STATE OF OBJECT, AND METHOD AND APPARATUS FOR TRAINING MODEL

(71) Applicant: Beijing Horizon Robotics Technology Research and Development Co., Ltd., Beijing (CN)

(72) Inventor: Shiqi TAN, Beijing (CN)

(73) Assignee: Beijing Horizon Robotics Technology Research and Development Co., Ltd., Beijing (CN)

(21) Appl. No.: 19/168,976

(22) PCT Filed: Mar. 15, 2024
(86) PCT No.: PCT/CN2024/081890

§ 371 Date: Sep. 25, 2025

(30) Foreign Application Priority Data
Mar. 27, 2023 (CN) 202310309049.4

(51) Int. Cl. G06V 20/58; G06T 7/246; G06V 10/77; G06V 10/80; G06V 20/70

(52) U.S. Cl. CPC G06V 20/58; G06T 7/246; G06V 10/7715; G06V 10/806; G06V 20/70; G06T 2207/30241; G06T 2207/30252; G06V 2201/07

(57) ABSTRACT

A method and apparatus for determining a perception result state of an object, and a model training method and apparatus. The method for determining a perception result state of an object comprises: acquiring a perception result and map element information corresponding to each time frame in at least one time frame (201); on the basis of the perception result corresponding to each time frame, determining first trajectory information corresponding to a target object in objects, and second trajectory information of another object around the target object (202); on the basis of the first trajectory information, the second trajectory information, and the map element information, determining a detection result corresponding to the target object by using a pre-trained perception result state detection model (203); and determining a perception result state of the target object on the basis of the detection result (204). The methods and apparatuses can improve the generalization capability of recognizing an object on which abnormal perception occurs to cover more abnormal perception situations, and improve the working efficiency and the processing efficiency.

### CROSS-REFERENCE TO RELEVANT APPLICATION

This application claims the benefit of priority to Chinese patent application No. CN202310309049.4 filed on Mar. 27, 2023 to China National Intellectual Property Administration, titled “METHOD AND APPARATUS FOR DETERMINING PERCEPTION RESULT STATE OF OBJECT, AND METHOD AND APPARATUS FOR TRAINING MODEL”, which is hereby incorporated by reference in its entirety.

### FIELD OF THIS DISCLOSURE

This disclosure relates to artificial intelligence technology, in particular to a method and apparatus for determining a perception result state of an object, and a method and apparatus for training a model.

### BACKGROUND OF THIS DISCLOSURE

In a field such as autonomous driving, assisted driving, etc., perception stability greatly impacts an effect of trajectory prediction, and may impact vehicle planning and control. At present, due to limitation of perception capability, abnormal perception still cannot be avoided completely. Therefore, in subsequent trajectory prediction, an abnormally perceived object (or obstacle) generally has to be identified, to prevent or reduce interference thereof on trajectory prediction or even vehicle planning and control, as well as poor user experience thus brought. If an abnormally perceived object is identified based on a manually designed rule for identification, it easily causes problems such as low efficiency of development, poor ability of generalization, limited coverage of abnormal perception cases, etc.

### SUMMARY OF THIS DISCLOSURE

Embodiments of this disclosure provide a method and apparatus for determining a perception result state of an object, and a method and apparatus for training a model, which helps improve ability of generalization of identifying an abnormally perceived object, and improve efficiency of operation and efficiency of processing.

A first aspect of embodiments of this disclosure provides a method for determining a perception result state of an object, including: obtaining a respective perception result of at least one time frame and map element information, the respective perception result including state information of at least one object in a first coordinate system; determining, based on the respective perception result of the at least one time frame, first trajectory information corresponding to a target object of the at least one object, and second trajectory information of at least one second object around the target object; determining a detection result corresponding to the target object based on the first trajectory information, the second trajectory information, and the map element information using a trained perception result state detection model; and determining a perception result state of the target object based on the detection result.

A second aspect of embodiments of this disclosure provides a method for training a perception result state detection model, including: obtaining first training trajectory information corresponding to a respective training target object in at least one training target object, second training trajectory information of at least one second training object around the respective training target object, and map element information corresponding to the respective training target object; and training a pre-established perception result state detection network based on the first training trajectory information, the second training trajectory information, and the map element information, to obtain a trained perception result state detection model.

A third aspect of embodiments of this disclosure provides an apparatus for determining a perception result state of an object, including: a first obtaining module configured for obtaining a respective perception result of at least one time frame and map element information, the respective perception result including state information of at least one object in a first coordinate system; a first processing module configured for determining, based on the respective perception result of the at least one time frame, first trajectory information corresponding to a target object of the at least one object, and second trajectory information of at least one second object around the target object; a second processing module configured for determining a detection result corresponding to the target object based on the first trajectory information, the second trajectory information, and the map element information using a trained perception result state detection model; and a third processing module configured for determining a perception result state of the target object based on the detection result.

A fourth aspect of embodiments of this disclosure provides an apparatus for training a perception result state detection model, including: a second obtaining module configured for obtaining first training trajectory information corresponding to a respective training target object in at least one training target object, second training trajectory information of at least one second training object around the respective training target object, and map element information corresponding to the respective training target object; and a fourth processing module configured for training a pre-established perception result state detection network based on the first training trajectory information, the second training trajectory information, and the map element information, to obtain a trained perception result state detection model.

A fifth aspect of embodiments of this disclosure provides a computer-readable storage medium having a computer program stored thereon, when executed by a processor, the computer program implements the method for determining a perception result state of an object according to any one embodiment of this disclosure; or the method for training a perception result state detection model according to any one embodiment of this disclosure.

A sixth aspect of embodiments of this disclosure provides an electronic device, the electronic device including: a processor; and a memory configured for storing a processor-executable instruction, wherein the processor is configured for reading and executing the executable instruction in the memory to implement the method for determining a perception result state of an object according to any one embodiment of this disclosure; or the method for training a perception result state detection model according to any one embodiment of this disclosure.

Embodiments of a seventh aspect of this disclosure propose a computer program product. When instructions in the computer program product are executed by a processor, the method for determining a perception result state of an object according to any one embodiment of this disclosure or the method for training a perception result state detection model according to any one embodiment of this disclosure is implemented.

Based on a method and apparatus for determining a perception result state of an object, and a method and apparatus for training a model according to embodiments of this disclosure, it is enabled to determine the perception result state of the target object based on trajectory information of the target object itself, trajectory information of the at least one second object around, and information on a map element around using the trained perception result state detection model, which helps improve ability of generalization of identifying an abnormally perceived object, to cover more abnormal perception cases, and helps improve efficiency of operation and efficiency of processing compared to a manually designed rule.

A technical solution of this disclosure is further elaborated below using accompanying drawings and embodiments.

### BRIEF DESCRIPTION OF THE DRAWINGS

FIG. 1 is an illustrative scene of application of a method for determining a perception result state of an object according to this disclosure;

FIG. 2 is a flowchart of a method for determining a perception result state of an object according to an illustrative embodiment of this disclosure;

FIG. 3 is a flowchart of a method for determining a perception result state of an object according to another illustrative embodiment of this disclosure;

FIG. 4 is a diagram of a target coordinate system according to an illustrative embodiment of this disclosure;

FIG. 5 is a diagram of a trajectory of first trajectory information of a target object according to an illustrative embodiment of this disclosure;

FIG. 6 is a flowchart of a method for determining a perception result state of an object according to yet another illustrative embodiment of this disclosure;

FIG. 7 is a diagram of a structure of an attention network according to an illustrative embodiment of this disclosure;

FIG. 8 is a flowchart of a method for determining a perception result state of an object according to still another illustrative embodiment of this disclosure;

FIG. 9 is a flowchart of a method for training a perception result state detection model according to an illustrative embodiment of this disclosure;

FIG. 10 is a flowchart of a method for training a perception result state detection model according to another illustrative embodiment of this disclosure;

FIG. 11 is a diagram of a structure of a joint task network according to an illustrative embodiment of this disclosure;

FIG. 12 is a flowchart of a method for training a perception result state detection model according to yet another illustrative embodiment of this disclosure;

FIG. 13 is a diagram of a structure of an apparatus for determining a perception result state of an object according to an illustrative embodiment of this disclosure;

FIG. 14 is a diagram of a structure of an apparatus for determining a perception result state of an object according to another illustrative embodiment of this disclosure;

FIG. 15 is a diagram of a structure of an apparatus for training a perception result state detection model according to an illustrative embodiment of this disclosure; and

FIG. 16 is a diagram of a structure of an embodiment of application of an electronic device according to this disclosure.

### DESCRIPTION OF THE EMBODIMENTS

To explain this disclosure, illustrative embodiments of this disclosure are elaborated below with reference to accompanying drawings. Clearly, the embodiments described are merely some, rather than all, embodiments of this disclosure. It should be understood that this disclosure is not limited to the illustrative embodiments.

It should be noted that unless otherwise specified, the scope of this disclosure is not limited to relative arrangements, numeric expressions, and numerical values of components and steps described in these embodiments.

### Disclosure Overview

In implementing this disclosure, the inventor discovers that in a field such as autonomous driving, assisted driving, etc., perception stability greatly impacts an effect of trajectory prediction, and may impact vehicle planning and control. At present, due to limitation of perception capability, abnormal perception still cannot be avoided completely. Therefore, in subsequent trajectory prediction, an abnormally perceived object (or obstacle) generally has to be identified, to prevent or reduce interference thereof on trajectory prediction or even vehicle planning and control, as well as poor user experience thus brought. If an abnormally perceived object is identified based on a manually designed rule for identification to obtain information on the abnormally perceived object, as the rule for identification may involve various aspects such as whether there is a jump in a yaw angle of the object, whether a type of the object is stable, whether there is a lateral drift of the object, etc., it easily causes low efficiency of development of the manually designed rule, poor ability of generalization, limited coverage of abnormal perception cases, etc.

### Illustrative Overview

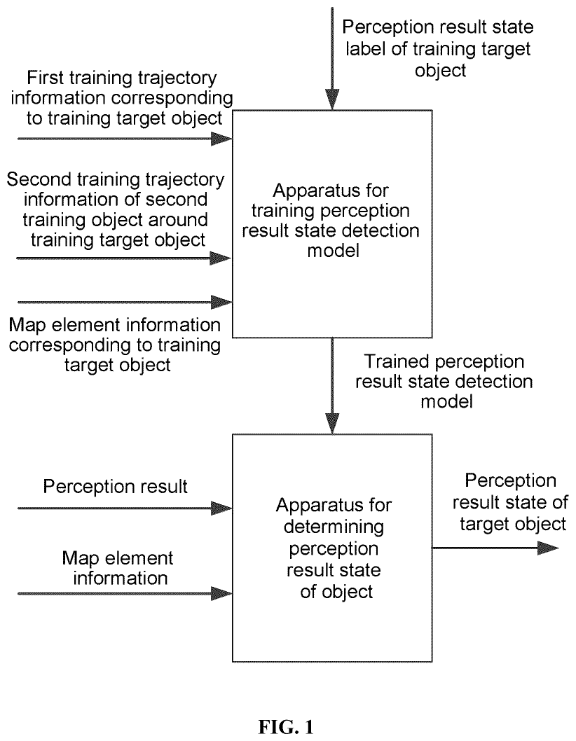

FIG. 1 is an illustrative scene of application of a method for determining a perception result state of an object according to this disclosure.

In a scene of application such as autonomous driving, assisted driving, etc., using the method for determining a perception result state of an object according to this disclosure, a pre-established perception result state detection network may be trained in advance based on first training trajectory information corresponding to a respective training target object in at least one training target object, second training trajectory information of at least one second training object around, and map element information of an area where the respective training target object is located, to obtain a trained perception result state detection model, wherein the perception result state detection model may be deployed in an apparatus for determining a perception result state of an object on a vehicle, and while the vehicle drives, a respective perception result of at least one time frame and map element information may be obtained, wherein the respective perception result may include perceived state information of at least one object in a first coordinate system, the first coordinate system may be a world coordinate system, or a vehicle coordinate system corresponding to a time frame, with specifics of which not being limited, and a transformation between the world coordinate system and the vehicle coordinate system may be performed through position and pose of the vehicle. First trajectory information corresponding to a target object of the at least one object, and second trajectory information of at least one second object around the target object, may be determined based on the respective perception result of the at least one time frame; a detection result of the target object may be determined based on the first trajectory information, the second trajectory information, and the map element information using a trained perception result state detection model, and then, a perception result state of the target object may be determined based on the detection result. The perception result state may include a normal state and an abnormal state. The first trajectory information may include at least one piece of information such as position, pose, velocity, acceleration, etc., of the target object corresponding to the at least one time frame. Similarly, the second trajectory information may include at least one piece of information such as position, pose (heading or angle), velocity, acceleration, etc., of the at least one second object corresponding to the at least one time frame. Specifics may be set as needed. The map element information may include information on a static element such as a lane line, a curb, etc.

With embodiments of this disclosure, it is enabled to determine accuracy of a perception result state of an object based on a perception result state detection model, which helps improve ability of generalization of identifying an abnormally perceived object, to cover more abnormal perception cases, and helps improve efficiency of operation and efficiency of processing compared to a manually designed rule.

### Illustrative Method

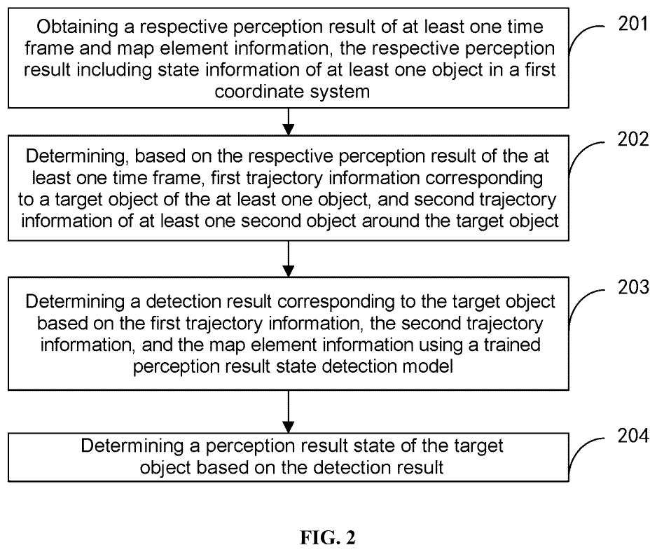

FIG. 2 is a flowchart of a method for determining a perception result state of an object according to an illustrative embodiment of this disclosure. This embodiment is applicable to an electronic device, such as an onboard computing platform. As shown in FIG. 2, the method according to embodiments of this disclosure may include steps as follows.

Step 201, Obtaining a respective perception result of at least one time frame and map element information, the respective perception result including state information of at least one object in a first coordinate system

The at least one time frame may be set as needed. For example, while the vehicle drives, the at least one time frame may include a current time frame and at least one historical time frame. The first coordinate system may be a world coordinate system, a map coordinate system, or a vehicle coordinate system corresponding to a time frame, and may specifically be set as needed. The at least one object may include a dynamic object such as another vehicle, a pedestrian, etc., perceived around this vehicle, and may also include this vehicle. The map element information may include information on a static element such as a lane line, a curb, etc. Regarding the map element information, each time frame may correspond to one group of map element information, or all the at least one time frame may correspond to one group of map element information, which may be set specifically as needed. State information of an object may include at least one piece of perceived information of a position, a pose, a velocity, an angular velocity, an acceleration, and a type of the object, etc. The type may refer to a perceived category of the object, wherein for example, the object is a vehicle, a pedestrian, or another obstacle.

In an optional embodiment, a perception result may be obtained based on data acquired by at least one of sensors such as a camera, light detection and ranging LIDAR, millimeter-wave radar, ultrasonic radar, etc., and respective perception algorithm or perception model. For example, an image acquired by a camera on the vehicle may be processed based on a trained target detection model, to obtain a type and a box of detection of a respective object included in the image, a point cloud corresponding to the respective object is obtained based on LIDAR, and a state of the respective object in the first coordinate system is determined combining a radar point cloud and an image detection result. A specific mode of obtaining a perception result may be set as needed.

In an optional embodiment, the map element information may be extracted from a map of a respective area. The respective area may be determined based on respective position and pose of the vehicle corresponding to the at least one time frame. The map describes information relevant to various elements, such as information relevant to an element such as a lane line, a curb, etc. A preset range around the vehicle may be determined based on the position or the position and pose of the vehicle in the map corresponding to the at least one time frame, and information on a relevant element within the preset range in the map may be set to be map element information.

In an optional example, step 201 may be implemented by a processor by calling a respective instruction stored in a memory, or implemented by a first obtaining module run by a processor.

Step 202, Determining, based on the respective perception result of the at least one time frame, first trajectory information corresponding to a target object of the at least one object, and second trajectory information of at least one second object around the target object

The target object may be determined based on an object in a perception result corresponding to the current time frame, or determined combining perception results corresponding to a plurality of time frames. For example, the target object may be any on object in the perception result corresponding to the current time frame. The number of target objects may be set as needed, where for example, each object in the perception result corresponding to the current time frame may be set to be a target object, which may specifically be set as needed. The first trajectory information may include respective position and pose of the target object corresponding to the at least one time frame, and may also include the velocity, the acceleration, etc., specifics of which may be set as needed.

In an optional embodiment, the at least one object in the respective perception result of the at least one time frame may also be identified based on a preset rule for identification, to determine that a perception result state of a first object meeting the preset rule for identification is an abnormal state, and the first object is removed from the respective perception result, to obtain a filtered perception result, and then, the first trajectory information corresponding to the target object of the at least one object, and the second trajectory information of the at least one second object around the target object, are determined based on the filtered perception result corresponding to the at least one time frame. The preset rule for identification may be set as needed, and may include, for example, a rule such as whether there is a jump in a yaw angle of the object, whether a type of the object is stable, whether there is a lateral drift of the object, etc. First, an obviously abnormal object is preliminarily identified based on the preset rule for identification. Then, subsequent processing is performed on a remaining object, to perceive its perception result state.

In an optional embodiment, the number of second objects around the target object may be 0, 1, or more, with specifics of which not being limited. In actual application, a format of input of the second trajectory information of the at least one second object may be set to adapt to a perception result state detection model, wherein for example, the format of input is set to a first number of (such as 16) pieces of second trajectory information of the at least one second object. If the number of second objects around the target object does not meet the first number, or there is no second object around the target object, the part of second trajectory information of an actually non-existing second object may be denoted by a filling of a null value (such as 0). For example, if there are actually 5 second objects around the target object, in the format of input denoting the second trajectory information of the 16 second objects, there are valid data in second trajectory information of the 5 second objects, and second trajectory information of the remaining 11 second objects is filled with null values, thereby enabling the second trajectory information of the second objects to meet an input needed by the model.

In an optional example, step 202 may be implemented by a processor by calling a respective instruction stored in a memory, or implemented by a first processing module run by a processor.

Step 203, Determining a detection result corresponding to the target object based on the first trajectory information, the second trajectory information, and the map element information using a trained perception result state detection model

A specific structure of the perception result state detection model may be set as needed, and may use, for example, a detection model based on a convolutional neural network and an attention network, which is not limited in this embodiment. The detection result corresponding to the target object may include a probability of a perception result state of the target object predicted by the model, wherein the probability of the perception result state may include at least one of a first probability that the perception result state is a first state and a second probability that the perception result state is a second state. The first state may be the normal state, and the second state may be the abnormal state; or the first state may be the abnormal state, and the second state be the normal state, specifics of which may be set as needed. A mode of denoting the first state and the second state may be set as needed, wherein for example, the first state is denoted by 1, and the second state by 0.

In an optional example, step 203 may be implemented by a processor by calling a respective instruction stored in a memory, or implemented by a second processing module run by a processor.

Step 204, Determining a perception result state of the target object based on the detection result

In an optional embodiment, the perception result state of the target object may be determined based on the probability of the perception result state included in the detection result and a corresponding probability threshold. The probability threshold may be set as needed.

In an optional example, step 204 may be implemented by a processor by calling a respective instruction stored in a memory, or implemented by a third processing module run by a processor.

With the method for determining a perception result state of an object according to this embodiment, it is enabled to determine the perception result state of the target object based on trajectory information of the target object itself, trajectory information of the at least one second object around, and information on a map element around using the trained perception result state detection model, which helps improve ability of generalization of identifying an abnormally perceived object, to cover more abnormal perception cases, and helps improve efficiency of operation and efficiency of processing compared to a manually designed rule.

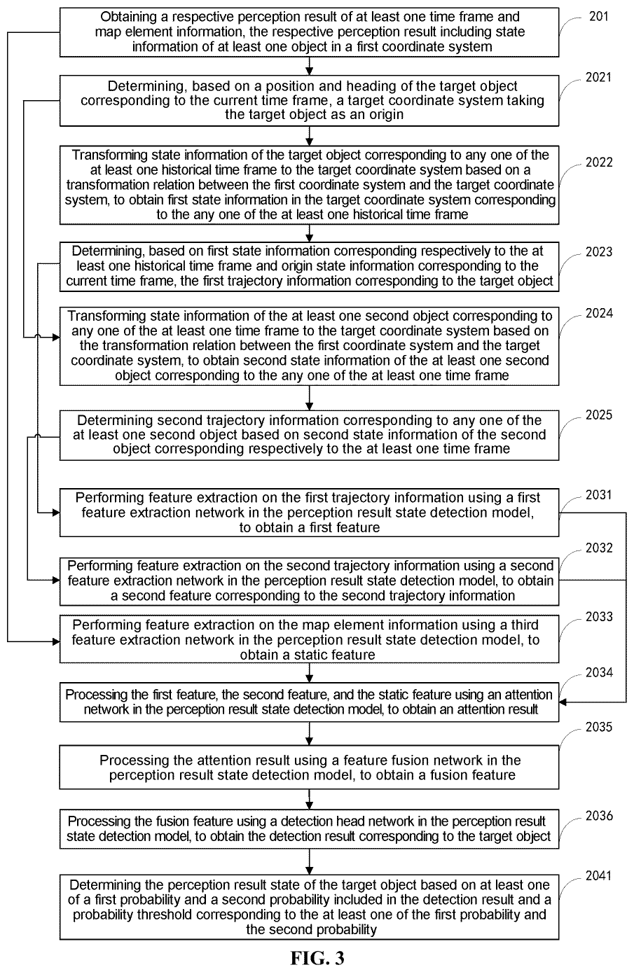

FIG. 3 is a flowchart of a method for determining a perception result state of an object according to another illustrative embodiment of this disclosure.

In an optional embodiment, the at least one time frame may include a current time frame and at least one historical time frame, and the state information may include a position and heading of the at least one object.

The position may include spatial coordinates of the at least one object in the first coordinate system, and the heading may include a pose or angle of the at least one object in the first coordinate system, such as a direction in which a vehicle advances.

In an optional embodiment, in step 202, the determining, based on the respective perception result of the at least one time frame, first trajectory information corresponding to a target object of the at least one object may include steps as follows.

Step 2021, Determining, based on a position and heading of the target object corresponding to the current time frame, a target coordinate system taking the target object as an origin

The target coordinate system may be a coordinate system which takes the position of the target object corresponding to the current time frame as the origin, the heading of the target object corresponding to the current time frame as a first coordinate axis, and a direction perpendicular to the heading of the target object as a second coordinate axis. For example, if the object is a vehicle, the target coordinate system may be a vehicle coordinate system of the vehicle, with a center of a rear axle of the vehicle being taken as the origin, a direction in a length of the vehicle as the first coordinate axis, and a direction in a width of the vehicle as the second coordinate axis.

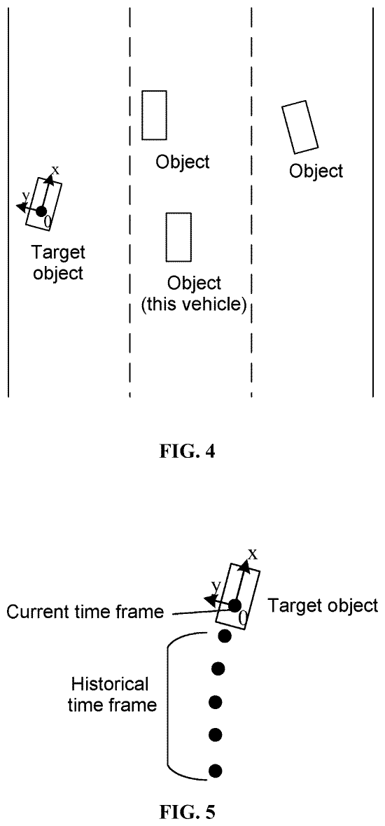

Illustratively, FIG. 4 is a diagram of a target coordinate system according to an illustrative embodiment of this disclosure. x0y denotes the target coordinate system of the target object.

In an optional example, step 2021 may be implemented by a processor by calling a respective instruction stored in a memory, or implemented by a first determining unit run by a processor.

Step 2022, Transforming state information of the target object corresponding to any one of the at least one historical time frame to the target coordinate system based on a transformation relation between the first coordinate system and the target coordinate system, to obtain first state information in the target coordinate system corresponding to the any one of the at least one historical time frame

If the first coordinate system is the world coordinate system or the map coordinate system, the transformation relation between the first coordinate system and the target coordinate system may be determined based on a rotation and a translation of the target coordinate system relative to the first coordinate system. If the first coordinate system is the vehicle coordinate system in the corresponding time frame, the transformation relation between the first coordinate system and the target coordinate system may be determined based on a transformation relation between the vehicle coordinate system and the world coordinate system and a transformation relation between the world coordinate system and the target coordinate system. The state information of the target object corresponding to any one of the at least one historical time frame may be transformed to the target coordinate system based on the transformation relation, to obtain the first state information in the target coordinate system corresponding to the any one of the at least one historical time frame, with specifics of a principle for the transformation not repeated. The first state information may include position and pose in the target coordinate system. Based on this, respective state information of the target object corresponding to the at least one time frame in the target coordinate system may be obtained.

In an optional example, step 2022 may be implemented by a processor by calling a respective instruction stored in a memory, or implemented by a first transforming unit run by a processor.

Step 2023, Determining, based on first state information corresponding respectively to the at least one historical time frame and origin state information corresponding to the current time frame, the first trajectory information corresponding to the target object

The origin state information may be first state information of the target object in the target coordinate system. Each of the current time frame and the at least one historical time frame may correspond to one state of the target object, based on which the first trajectory information corresponding to the target object may be determined.

Illustratively, FIG. 5 is a diagram of a trajectory of first trajectory information of a target object according to an illustrative embodiment of this disclosure. In this example, the at least one time frame may include the current time frame and 5 historical time frames, and the first trajectory information of the target object in the target coordinate system is determined.

In an optional example, step 2023 may be implemented by a processor by calling a respective instruction stored in a memory, or implemented by a second determining unit run by a processor.

In this embodiment, the state information of the target object corresponding to the at least one time frame in the first coordinate system is transformed to the target coordinate system taking the target object as the origin, which facilitates determining a relation between the state of the target object corresponding to a historical time frame and the state corresponding to the current time frame, as well as a relation of a second object and a map element to the state of the target object corresponding to the current time frame, which provides more effective data for determining the perception result state of the target object corresponding to the current time frame.

In an optional embodiment, in step 202, the determining, based on the respective perception result of the at least one time frame, the second trajectory information of the at least one second object around the target object may include steps as follows.

Step 2024, Transforming state information of the at least one second object corresponding to any one of the at least one time frame to the target coordinate system based on the transformation relation between the first coordinate system and the target coordinate system, to obtain second state information of the at least one second object corresponding to the any one of the at least one time frame

The transformation of the state information of the at least one second object corresponding to the at least one time frame to the target coordinate system is similar to that of the target object as described above, which is not repeated here.

In an optional example, step 2024 may be implemented by a processor by calling a respective instruction stored in a memory, or implemented by a second transforming unit run by a processor.

Step 2025, Determining second trajectory information corresponding to any one of the at least one second object based on second state information of the second object corresponding respectively to the at least one time frame

The determination of the second trajectory information is similar to that of the first trajectory information as described above, which is not repeated here.

In an optional embodiment, if there is at least one second object around the target object, second trajectory information corresponding to each of the at least one second object may be determined in a mode as described above.

In an optional embodiment, if there is no second object around the target object, processing in steps 2024 to 2025 is not needed, it may be directly determined that the second trajectory information of the respective second object input to the model is filled with the null value.

In an optional example, step 2025 may be implemented by a processor by calling a respective instruction stored in a memory, or implemented by a third determining unit run by a processor.

In this embodiment, the state information of the at least one second object in the at least one time frame is transformed to the target coordinate system of the target object, and prediction of the perception result state of the target object by the model is assisted based on position and pose of the at least one second object relative to the target object, which helps further improve accuracy of a predicted result.

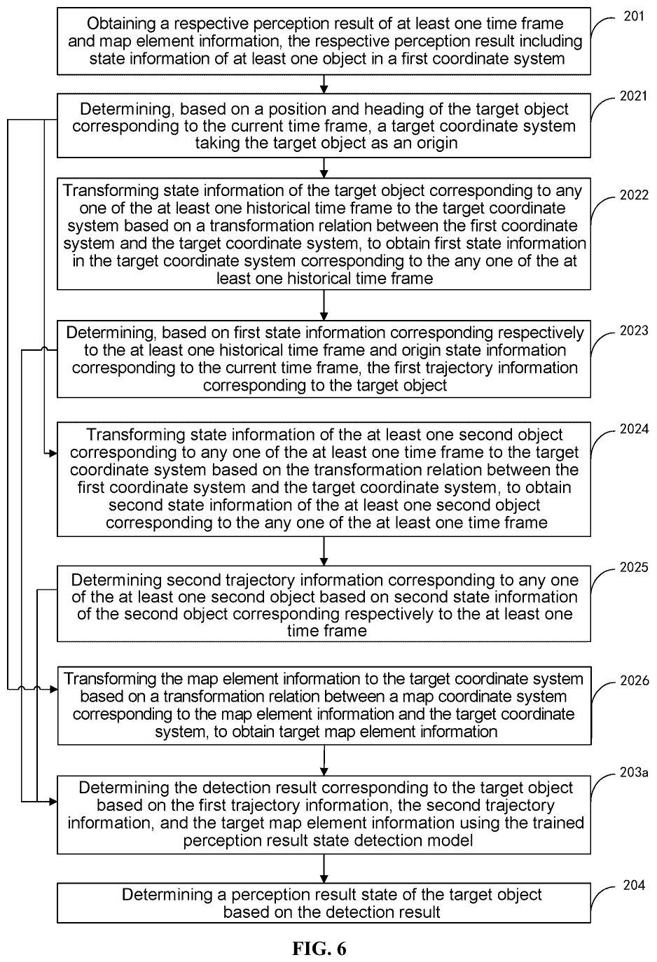

FIG. 6 is a flowchart of a method for determining a perception result state of an object according to yet another illustrative embodiment of this disclosure.

In an optional embodiment, the method according to embodiments of this disclosure may further include a step as follows.

Step 2026, Transforming the map element information to the target coordinate system based on a transformation relation between a map coordinate system corresponding to the map element information and the target coordinate system, to obtain target map element information

The principle of determining the transformation relation between the map coordinate system and the target coordinate system is similar to that for the first coordinate system as described above, which is not repeated here.

In an optional example, step 2026 may be implemented by a processor by calling a respective instruction stored in a memory, or implemented by a third transforming unit run by a processor.

In step 203, the determining a detection result corresponding to the target object based on the first trajectory information, the second trajectory information, and the map element information using a trained perception result state detection model may include a step as follows.

Step 203a, Determining the detection result corresponding to the target object based on the first trajectory information, the second trajectory information, and the target map element information using the trained perception result state detection model

In an optional embodiment, in a training process, the perception result state detection model may be trained based on first training trajectory information of a training target object, second training trajectory information of at least one second training object around the training target object, and map element information unified to one coordinate system, as well. Refer to a subsequent respective embodiment of the method for training for specifics of the training process.

In an optional example, step 203a may be implemented by a processor by calling a respective instruction stored in a memory, or implemented by the second processing module run by a processor.

In this embodiment, it is enabled to transform the map element information to the target coordinate system, which enables the map element information to be unified to the same coordinate system as the first trajectory information and the second trajectory information, which enables to further improve accuracy in denoting the relation between a target object, a second object, and a map element, thereby improving accuracy of a perception result state.

In an optional embodiment, step 203 may specifically include steps as follows.

Step 2031, Performing feature extraction on the first trajectory information using a first feature extraction network in the perception result state detection model, to obtain a first feature

The first feature extraction network may adopt any feature extraction network that can be implemented, such as a series of feature extraction networks based on a convolutional neural network, specifically such as a feature extraction network based on a visual geometry group net (VGGNet), a feature extraction network based on a residual network (Resnet), etc., with specifics of which not being limited.

In an optional example, step 2031 may be implemented by a processor by calling a respective instruction stored in a memory, or implemented by a first processing unit run by a processor.

Step 2032, Performing feature extraction on the second trajectory information using a second feature extraction network in the perception result state detection model, to obtain a second feature corresponding to the second trajectory information

The second feature extraction network may adopt any feature extraction network that can be implemented, such as a feature extraction network based on a visual geometry group net (VGGNet), a feature extraction network based on a residual network (Resnet), etc., with specifics of which not being limited.

In an optional example, step 2032 may be implemented by a processor by calling a respective instruction stored in a memory, or implemented by a second processing unit run by a processor.

Step 2033, Performing feature extraction on the map element information using a third feature extraction network in the perception result state detection model, to obtain a static feature

The third feature extraction network may adopt any feature extraction network that can be implemented, such as a feature extraction network based on a visual geometry group net (VGGNet), a feature extraction network based on a residual network (Resnet), etc., with specifics of which not being limited.

In an optional embodiment, network structures of the first feature extraction network, the second feature extraction network and the third feature extraction network may be set to be the same or different as needed, which is not limited in embodiments of this disclosure.

In an optional embodiment, the first feature extraction network and the second feature extraction network may be the same feature extraction network.

Step 2031, step 2032, and step 2033 are in no particular order.

In an optional example, step 2033 may be implemented by a processor by calling a respective instruction stored in a memory, or implemented by a third processing unit run by a processor.

Step 2034, Processing the first feature, the second feature, and the static feature using an attention network in the perception result state detection model, to obtain an attention result

A specific structure of the attention network may be set as needed, and the attention network is configured for cross attention of the first feature on the second feature and the static feature, which thereby enables to obtain feature correlation of the first feature with the second feature and the static feature.

Illustratively, the attention network may include a self-attention layer, a cross-attention layer, and another relevant layer, such as an addition and normalization Add&Norm layer, with specifics of which not being limited. The attention network may be a single-head attention network or a multi-head attention network, with specifics of which not being limited.

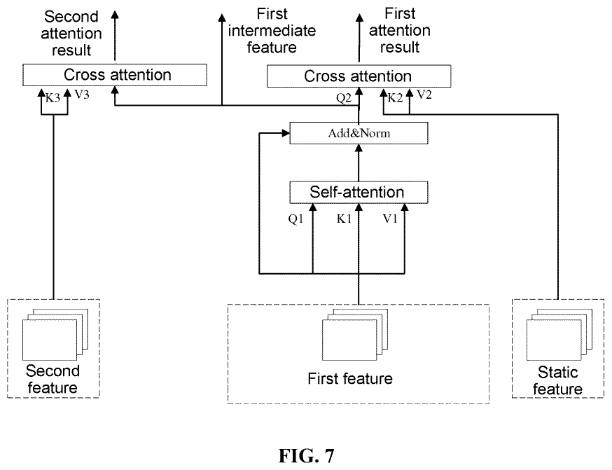

Illustratively, FIG. 7 is a diagram of a structure of an attention network according to an illustrative embodiment of this disclosure. The first feature may be mapped to a first query vector Q1, a first key vector K1, and a first value vector V1 through a preset mapping relation, which go through the self-attention layer and the Add&Norm layer to obtain a first intermediate feature, wherein the first intermediate feature may be mapped to a second query vector Q2, the static feature may be mapped to a second key vector K2 and a second value vector V2, and the second feature may be mapped to a third key vector K3 and a third value vector V3; cross attention of the second query vector Q2 on the second key vector K2 and the second value vector V2 is performed, to obtain a first attention result, cross attention of the second query vector Q2 on the third key vector K3 and the third value vector V3 is performed, to obtain a second attention result, and the first attention result, the second attention result, and the first intermediate feature are set to be the attention result of the attention network. Here is just an illustrative structure, and in actual application, another possible structure may be set as needed, rather than being limited to the structure as described above.

In an optional example, step 2034 may be implemented by a processor by calling a respective instruction stored in a memory, or implemented by a fourth processing unit run by a processor.

Step 2035, Processing the attention result using a feature fusion network in the perception result state detection model, to obtain a fusion feature The feature fusion network may be a fully connected layer, and implement feature fusion of the attention result.

Illustratively, feature fusion may be performed on the first attention result, the second attention result, and the first intermediate feature obtained in the above example by concatenation (concat), to obtain the fusion feature.

In an optional example, step 2035 may be implemented by a processor by calling a respective instruction stored in a memory, or implemented by a fifth processing unit run by a processor.

Step 2036, Processing the fusion feature using a detection head network in the perception result state detection model, to obtain the detection result corresponding to the target object

The detection head network may be muti-layer perception (MLP) for mapping the fusion feature to the detection result.

In an optional example, step 2036 may be implemented by a processor by calling a respective instruction stored in a memory, or implemented by a sixth processing unit run by a processor.

In this embodiment, spatial correlation of the first feature of the first trajectory information of the target object with the second feature of the second trajectory information of the at least one second object around and the static feature of the map element information is implemented based on the attention network, for predicting the perception result state of the target object, which helps improve accuracy of a perception result state.

In an optional embodiment, the detection result may include at least one of a first probability that the perception result state of the target object is a first state and a second probability that the perception result state of the target object is a second state.

In an optional embodiment, in step 204, the determining a perception result state of the target object based on the detection result may include a step as follows.

Step 2041, Determining the perception result state of the target object based on the at least one of the first probability and the second probability included in the detection result and a probability threshold corresponding to the at least one of the first probability and the second probability

The probability threshold may be set as needed. For example, the probability threshold may include a first threshold corresponding to the first probability and a second threshold corresponding to the second probability, wherein the first threshold and the second threshold are respective thresholds configured for mapping the perception result state to the first probability and the second probability.

Illustratively, the first state is the normal state, wherein if the first probability is greater than the first threshold, it is determined that the perception result state is the normal state.

Illustratively, the second state is the abnormal state, wherein if the second probability is greater than the second threshold, it is determined that the perception result state is the abnormal state.

In an optional example, step 2041 may be implemented by a processor by calling a respective instruction stored in a memory, or implemented by a fourth determining unit run by a processor.

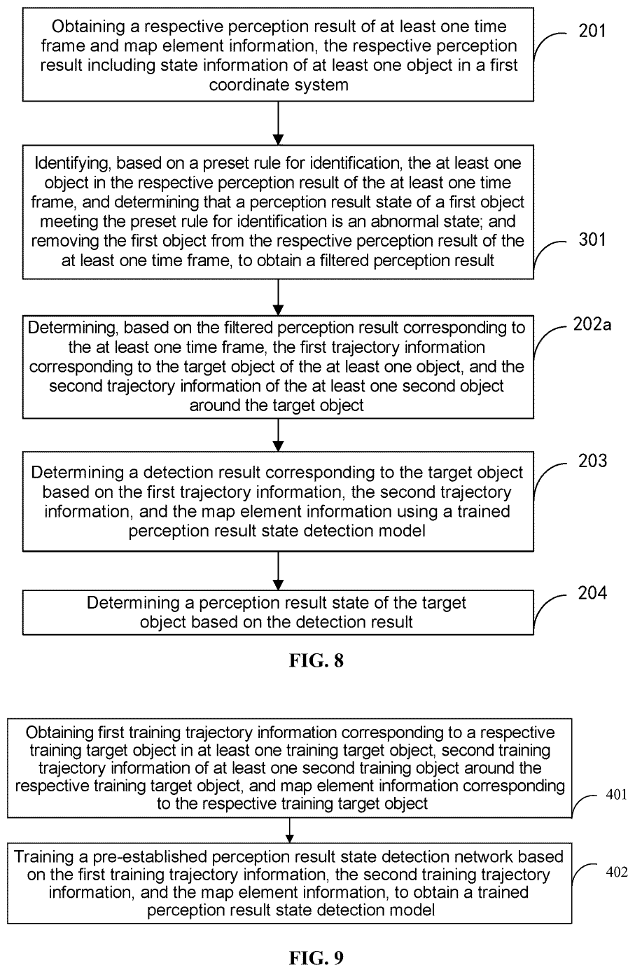

FIG. 8 is a flowchart of a method for determining a perception result state of an object according to still another illustrative embodiment of this disclosure.

In an optional embodiment, the method according to embodiments of this disclosure may further includes a step as follows.

Step 301, Identifying, based on a preset rule for identification, the at least one object in the respective perception result of the at least one time frame, and determining that a perception result state of a first object meeting the preset rule for identification is an abnormal state; and removing the first object from the respective perception result of the at least one time frame, to obtain a filtered perception result

The preset rule for identification may be set as needed, wherein for example, the preset rule for identification may include a rule such as whether there is a jump in a yaw angle of the object, whether a type of the object is stable, whether there is a lateral drift of the object, etc. If there is a jump in the yaw angle of the object, it may be determined that the perception result state of the object is abnormal; if the type of the object jumps, it may be determined that the perception result state of the object is abnormal; if there is a lateral drift of the object, it may be determined that the perception result state of the object is abnormal, etc. A jump in the yaw angle may refer to that a change in yaw angles corresponding to adjacent time frames is greater than a change threshold. Instability (jump) of the type of the object may refer to that one object corresponds to at least two types in at least one time frame, wherein for example, a certain object is of a vehicle type at time frame t-2, and of a pedestrian type at time frame t. A lateral drift of the object may refer to that a change in a lateral coordinate of the object exceeds a respective threshold, wherein the lateral coordinate may refer to a lateral coordinate of the object in a vehicle coordinate system corresponding to a time frame. Some object(s) perceived abnormally may be identified first based on the preset rule for identification, and a perception result state of a remaining object may be identified by subsequent processing.

In an optional example, step 301 may be implemented by a processor by calling a respective instruction stored in a memory, or implemented by a pre-processing module run by a processor.

In step 202, the determining, based on the respective perception result of the at least one time frame, first trajectory information corresponding to a target object of the at least one object, and second trajectory information of at least one second object around the target object may include a step as follows.

Step 202a, Determining, based on the filtered perception result corresponding to the at least one time frame, the first trajectory information corresponding to the target object of the at least one object, and the second trajectory information of the at least one second object around the target object

A specific operation of the step is similar to that of step 202 as described above, which is not repeated here.

In an optional example, step 202a may be implemented by a processor by calling a respective instruction stored in a memory, or implemented by the first processing module run by a processor.

In this embodiment, by first identifying an object in a perception result based on a preset rule for identification to identify an object obviously perceived abnormally, it is enabled, on one hand, to reduce an amount of data for subsequent prediction by the model, to improve efficiency of processing; and on the other hand, to reduce interference of the obviously abnormal object on model inference, to further improve accuracy of a perception result state.

Respective embodiments or optional examples of this disclosure may be implemented separately, or in any combination as long as it causes no conflict, specifics of which may be set as needed, and are not limited in embodiments of this disclosure.

Any one method for determining a perception result state of an object according to embodiments of this disclosure may be implemented by any appropriate device capable of data processing, including but not limited to a terminal device, a server, etc. Alternatively, the any one method for determining a perception result state of an object according to embodiments of this disclosure may be implemented by a processor. For example, the processor implements the any one method for determining a perception result state of an object mentioned in embodiments of this disclosure by calling respective instructions stored in a memory, which is not elaborated hereinafter.

FIG. 9 is a flowchart of a method for training a perception result state detection model according to an illustrative embodiment of this disclosure. This embodiment is applicable to an electronic device, specifically, such as a server, a terminal device, etc. As shown in FIG. 9, the method according to embodiments of this disclosure may include steps as follows.

Step 401, Obtaining first training trajectory information corresponding to a respective training target object in at least one training target object, second training trajectory information of at least one second training object around the respective training target object, and map element information corresponding to the respective training target object

A training target object may be determined based on pre-acquired perception result data, wherein the perception result data may include a respective perception result of at least one time frame. The first training trajectory information is similar to the first trajectory information as described above, and the second training trajectory information is similar to the second trajectory information as described above, which are not repeated here.

In an optional example, step 401 may be implemented by a processor by calling a respective instruction stored in a memory, or implemented by a second obtaining module run by a processor.

Step 402, Training a pre-established perception result state detection network based on the first training trajectory information, the second training trajectory information, and the map element information, to obtain a trained perception result state detection model

For a network structure of the perception result state detection network, one may refer to the perception result state detection model in embodiments as described above, which is not repeated here.

In an optional embodiment, state label data needed in model training may be determined based on a perception result of a training target object corresponding to a future time frame in the perception result data, thereby enabling model training to combine a historical sate, a current state, and a future state of the object, which further improves performance of the model. For a future time frame corresponding to a training target object, any one of a plurality of time frames corresponding to the perception result data may be set to be the current time frame; then, a time frame before the current time frame is a historical time frame, and a time frame after the current time frame is the future time frame.

In an optional embodiment, the perception result state detection model may be obtained by joint training based on the perception result state detection network and at least one of a trajectory prediction head network and a trajectory planning head network based on imitation learning, which improves performance of the perception result state detection model.

In an optional example, step 402 may be implemented by a processor by calling a respective instruction stored in a memory, or implemented by a fourth processing module run by a processor.

With the method for training a perception result state detection model according to embodiments of this disclosure, it is enabled to train the perception result state detection model based on first training trajectory information of a training target object, second training trajectory information of at least one second training object around the training target object, and map element information, to obtain a detection model capable of effectively detecting a perception result state of an object, for identifying an abnormally perceived object, which helps improve ability of generalization of identifying an abnormally perceived object, to cover more abnormal perception cases, and helps improve efficiency of operation and efficiency of processing compared to a manually designed rule.

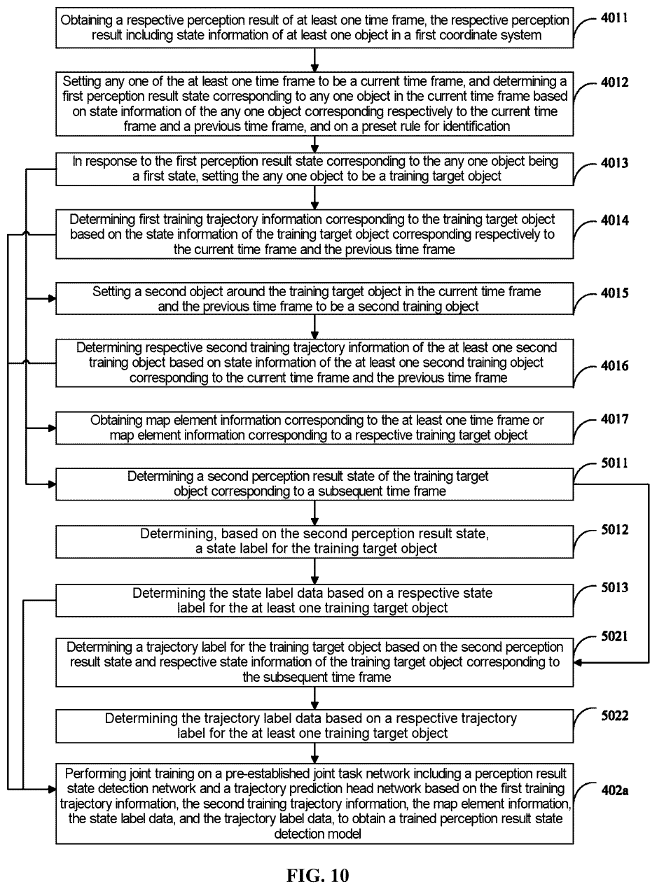

FIG. 10 is a flowchart of a method for training a perception result state detection model according to another illustrative embodiment of this disclosure.

In an optional embodiment, in step 401, the obtaining first training trajectory information corresponding to a respective training target object in at least one training target object, second training trajectory information of at least one second training object around the respective training target object may include steps as follows.

Step 4011, Obtaining a respective perception result of at least one time frame, the respective perception result including state information of at least one object in a first coordinate system

The at least one time frame may be that within any historical period of time, wherein for example, perception result data corresponding to a certain period of time while a vehicle actually drives may be obtained as the respective perception result of the at least one time frame, specifics of which may be set as needed. For the first coordinate system and the state information of an object, one may refer to embodiments as described above, which are not repeated here.

Step 4012, Setting any one of the at least one time frame to be a current time frame, and determining a first perception result state corresponding to any one object in the current time frame based on state information of the any one object corresponding respectively to the current time frame and a previous time frame, and on a preset rule for identification

For specifics of the preset rule for identification, one may refer to content as described above. Specifics such as position and pose of the any one object in the at least one time frame may be determined based on the state information of the any one object corresponding respectively to the current time frame and at least one previous time frame, and the position and pose of the any one object in the at least one time frame are matched to the preset rule for identification, to determine the perception result state of the any one object, to be the first perception result state. For example, if it is determined, based on the position and pose of the any one object in the at least one time frame, that there is a lateral drift of the any one object, it may be determined that the first perception result state of the any one object is the abnormal state.

Step 4013, In response to the first perception result state corresponding to the any one object being a first state, setting the any one object to be a training target object

The first state may be the normal state, if the first perception result state of the any one object is the normal state, the any one object may be set to be a training target object, to avoid adverse interference of taking an obviously abnormal object as a training target object on model training and inference.

In an optional embodiment, the second state may also be set as the normal state, in which case, step 4013 should be: in response to the first perception result state corresponding to the any one object being a second state, setting the any one object to be a training target object.

Step 4014, Determining first training trajectory information corresponding to the training target object based on the state information of the training target object corresponding respectively to the current time frame and the previous time frame

For determination of the first training trajectory information, one may refer to that of the first trajectory information as described above, which is not repeated here.

Step 4015, Setting a second object around the training target object in the current time frame and the previous time frame to be a second training object Step 4016, Determining respective second training trajectory information of the at least one second training object based on state information of the at least one second training object corresponding to the current time frame and the previous time frame

For determination of second training trajectory information, one may refer to that of the second trajectory information as described above, which is not repeated here.

Step 401 may further include a step as follows.

Step 4017, Obtaining map element information corresponding to the at least one time frame or map element information corresponding to a respective training target object

For the at least one time frame, the same group of map element information may be adopted, that is, the map element information includes map element information within an area range corresponding to the at least one time frame. The map element information corresponding to the respective training target object is the same group of map element information. Or, each training target object may correspond to one group of map element information, wherein the map element information includes map element information within a range related to the each training target object, with specifics of which not being limited.

In an optional example, steps 4011 to 4017 may be implemented by a processor by calling a respective instruction stored in a memory, or implemented by the second obtaining module run by a processor.

In this embodiment, a training target object is determined through historically-acquired perception result data, for training a perception result state detection model, which helps improve performance of the model.

In an optional embodiment, the method according to embodiments of this disclosure may further include steps as follows.

Step 5011, Determining a second perception result state of the training target object corresponding to a subsequent time frame

The subsequent time frame may include at least one future time frame relative to the current time frame, and the second perception result state may be determined based on a preset rule for identification, wherein for example, the second perception result state of the training target object may be determined based on whether there is a lateral drift of the training target object, whether a type of the training target object is unstable, whether there is a jump in a yaw angle of the training target object, etc., corresponding to the at least one future time frame. For example, if there is a lateral drift of the training target object corresponding to a future time frame, it may be determined that the second perception result state is the abnormal state. If no case matching the preset rule for identification occurs, it may be determined that the second perception result state is the normal state.

Step 5012, Determining, based on the second perception result state, a state label for the training target object

Different second perception result states may be denoted by different labels. For example, if the second perception result state is the normal state, the corresponding state label is 1 or 0; and accordingly, if the second perception result state is the abnormal state, the corresponding state label is 0 or 1.

Step 5013, Determining the state label data based on a respective state label for the at least one training target object

For a plurality of training target objects, training sample data of a plurality of training samples may be determined, wherein a state label corresponding to each training sample forms state label data corresponding to the training sample data.

In an optional example, steps 5011 to 5013 may be implemented by a processor by calling a respective instruction stored in a memory, or implemented by the second obtaining module run by a processor.

In this embodiment, a state label for a training target object is determined through a perception result of the training target object corresponding to a future time frame, for training the model. As the state label reflects truth of the training target object corresponding to the future time frame, combining a historical state, the current state, and a future state of the training target object enables to further improve performance of the model.

Step 402 may specifically include: training a pre-established perception result state detection network based on the first training trajectory information, the second training trajectory information, the map element information, and the state label data, to obtain the trained perception result state detection model.

In an optional embodiment, the method according to embodiments of this disclosure may further include steps as follows.

Step 5021, Determining a trajectory label for the training target object based on the second perception result state and respective state information of the training target object corresponding to the subsequent time frame

The trajectory label may include an output label and a corresponding trajectory type, wherein the trajectory type may be at least one preset type, wherein a preset type refers to a type of possible driving trajectories of a vehicle within a future period of time (such as 6 seconds) which is preset based on velocity of the vehicle, go-straight, turn, etc. In trajectory prediction, each preset type may correspond to one group of anchor trajectory points, wherein each group of anchor trajectory points may include a preset number of (such as 12) coordinate points, wherein the coordinate points may be coordinate points in a coordinate system taking an object (such as a training target object) of which a trajectory is to be predicted as the origin, wherein the coordinate points denote a possible future trajectory of the object, and a future trajectory of the object is determined by predicting a probability of the object falling into a preset type and offsets, wherein for example, sum of anchor trajectory points and offsets corresponding to at least one greatly probable preset type may be set to be future trajectory of the object. In training, a preset type of a true future trajectory of a training target object may be determined based on a future time frame corresponding to the training target object, and set to be the trajectory type of the trajectory label. The trajectory label may further include a no-output label. The output label denotes that the perception result state of the training target object is the normal state, and that a predicted trajectory may be output, whereas the no-output label denotes that the perception result state of the training target object is the abnormal state, and that trajectory prediction is not performed. A mode of denoting the trajectory label may be set as needed, and is not limited in this embodiment.

Step 5022, Determining the trajectory label data based on a respective trajectory label for the at least one training target object

In an optional example, steps 5021 and 5022 may be implemented by a processor by calling a respective instruction stored in a memory, or implemented by the second obtaining module run by a processor.

In step 402, the training a pre-established perception result state detection network based on the first training trajectory information, the second training trajectory information, and the map element information, to obtain a trained perception result state detection model may include a step as follows.

Step 402a, Performing joint training on a pre-established joint task network including a perception result state detection network and a trajectory prediction head network based on the first training trajectory information, the second training trajectory information, the map element information, the state label data, and the trajectory label data, to obtain a trained perception result state detection model

The joint task network may include the perception result state detection network and a trajectory prediction network, wherein the perception result state detection network and the trajectory prediction network may share a preceding part of the network, and implement different tasks through different head networks.

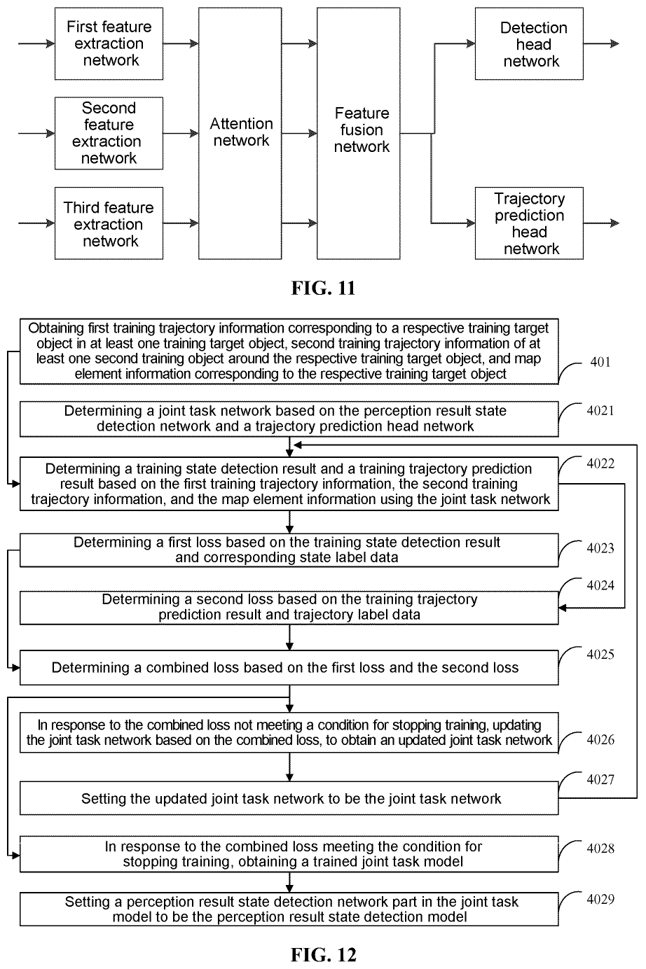

In an optional embodiment, FIG. 11 is a diagram of a structure of a joint task network according to an illustrative embodiment of this disclosure. As shown in FIG. 11, the joint task network may include a first feature extraction network, a second feature extraction network, a third feature extraction network, an attention network, a feature fusion network, a detection head network of a perception result state detection network, and a trajectory prediction head network of a trajectory prediction network. The first feature extraction network and the second feature extraction network may both be configured for extracting trajectory information, and the first feature extraction network and the second feature extraction network may adopt the same feature extraction network. In training, the first feature extraction network may be configured for performing feature extraction on first training trajectory information of a training target object, to obtain a first training feature; the second feature extraction network may be configured for performing feature extraction on second training trajectory information of at least one second training object around the training target object, to obtain a second training feature; the third feature extraction network may be configured for performing feature extraction on map element information, to obtain a static training feature; at the attention network, an attention operation may be performed on the extracted first training feature, second training feature, and static training feature, to obtain a training attention result; through the feature fusion network, feature fusion may be performed on the training attention result, to obtain a training fusion feature; through the detection head network, a training state detection result may be obtained using the training fusion feature; and through the trajectory prediction head network, a training trajectory prediction result may be obtained using the training fusion feature. A network loss may be determined based on a training perception result state detection result and corresponding state label data, as well as the training trajectory prediction result and corresponding trajectory label data. A network parameter of the joint task network may be updated based on the network loss, to obtain an updated joint task network. If the updated joint task network meets a condition for stopping training, the training stops; otherwise, the updated joint task network may continuously be updated iteratively based on the above process, until the updated joint task network meets the condition for stopping training, to obtain a joint task model, and then, a part other than the trajectory prediction head network in the joint task model may be set to be the trained perception result state detection model. Also, a part other than the detection head network may be set to be a trajectory prediction model. In model application, for specific application of a part of the network, refer to embodiments as described above, which are not repeated here.

In an optional example, step 402a may be implemented by a processor by calling a respective instruction stored in a memory, or implemented by the fourth processing module run by a processor.

In this embodiment, a trajectory label for a training target object is determined according to a perception result of the training target object corresponding to a future frame, and joint training is performed on the perception result state detection network and the trajectory prediction network, which enables to further improve performance of the perception result state detection model.

FIG. 12 is a flowchart of a method for training a perception result state detection model according to yet another illustrative embodiment of this disclosure.

In an optional embodiment, in step 402, the training a pre-established perception result state detection network based on the first training trajectory information, the second training trajectory information, and the map element information, to obtain a trained perception result state detection model may include steps as follows.

Step 4021, Determining a joint task network based on the perception result state detection network and a trajectory prediction head network

A specific network structure of the joint task network may be set as needed.

Step 4022, Determining a training state detection result and a training trajectory prediction result based on the first training trajectory information, the second training trajectory information, and the map element information using the joint task network

For a specific inference process of the step, one may refer to content described above, which is not repeated here.

Step 4023, Determining a first loss based on the training state detection result and corresponding state label data

The first loss may be determined based on a first preset loss function, wherein the first preset loss function may adopt any loss function that can be implemented, such as a mean square error loss function, a mean absolute error loss function, a cross entropy loss function, etc.

Step 4024, Determining a second loss based on the training trajectory prediction result and trajectory label data

The second loss may be determined based on a second preset loss function, wherein the second preset loss function may adopt any loss function that can be implemented, such as a mean square error loss function, a mean absolute error loss function, a cross entropy loss function, etc. Specifics thereof may be set as needed.

Step 4025, Determining a combined loss based on the first loss and the second loss

The combined loss may be obtained by weighting the first loss and the second loss based on preset weights, wherein specific preset weights may be set as needed, and are not limited in embodiments of this disclosure.

Step 4026, In response to the combined loss not meeting a condition for stopping training, updating the joint task network based on the combined loss, to obtain an updated joint task network

The condition for stopping training may include at least one of model convergence, a number of iteration reaching a preset number threshold, etc. The joint task network may be updated based on any gradient descent algorithm that can be implemented, such as a stochastic gradient descent algorithm, a stochastic average gradient descent algorithm, etc.

Step 4027, Setting the updated joint task network to be the joint task network, and returning to step 4022

Step 4028, In response to the combined loss meeting the condition for stopping training, obtaining a trained joint task model

Step 4029, Setting a perception result state detection network part in the joint task model to be the perception result state detection model

In an optional example, steps 4021 and 4029 may be implemented by a processor by calling a respective instruction stored in a memory, or implemented by the fourth processing module run by a processor.

In this embodiment, network parameter update combining losses of two tasks is enabled by performing joint training on the perception result state detection network and the trajectory prediction network, which enables to further improve performance of the model.

In embodiments of this disclosure, a potential feature of an obstacle perceived abnormally, such as a position distribution, an obstacle around, obstruction, etc., may be captured by model learning, which helps improve efficiency of processing and performance of generalization of identifying an abnormally perceived object. Moreover, in training, it is enabled to make full use of a future trajectory, to consider possible association between a current state of an obstacle and the future trajectory, which enables to further improve accuracy of a perception result state compared to determination through just a historical trajectory. In addition, the trained model is used to identify an obstacle perceived abnormally, which enables to reduce a delay brought by various rule-based determinations in actual application, enabling faster and more efficient identification.

Respective embodiments or optional examples of this disclosure may be implemented separately, or in any combination as long as it causes no conflict, specifics of which may be set as needed, and are not limited in embodiments of this disclosure.

Any one method for training a perception result state detection model according to embodiments of this disclosure may be implemented by any appropriate device capable of data processing, including but not limited to a terminal device, a server, etc. Alternatively, the any one method for training a perception result state detection model according to embodiments of this disclosure may be implemented by a processor. For example, the processor implements the any one method for training a perception result state detection model mentioned in embodiments of this disclosure by calling respective instructions stored in a memory, which is not elaborated hereinafter.

A person of ordinary skill in the art may understand that: all or some of the steps implementing a method embodiment as described above may be completed by instructing related hardware using a program; the foregoing program may be stored in a computer readable storage medium, and when executed, executes steps including the method embodiment as described above; and the foregoing storage medium includes various media capable of storing a program code, such as a read-only memory (ROM), a random access memory (RAM), a disk or a compact disk read-only memory (CD-ROM), etc.

### Illustrative Apparatus

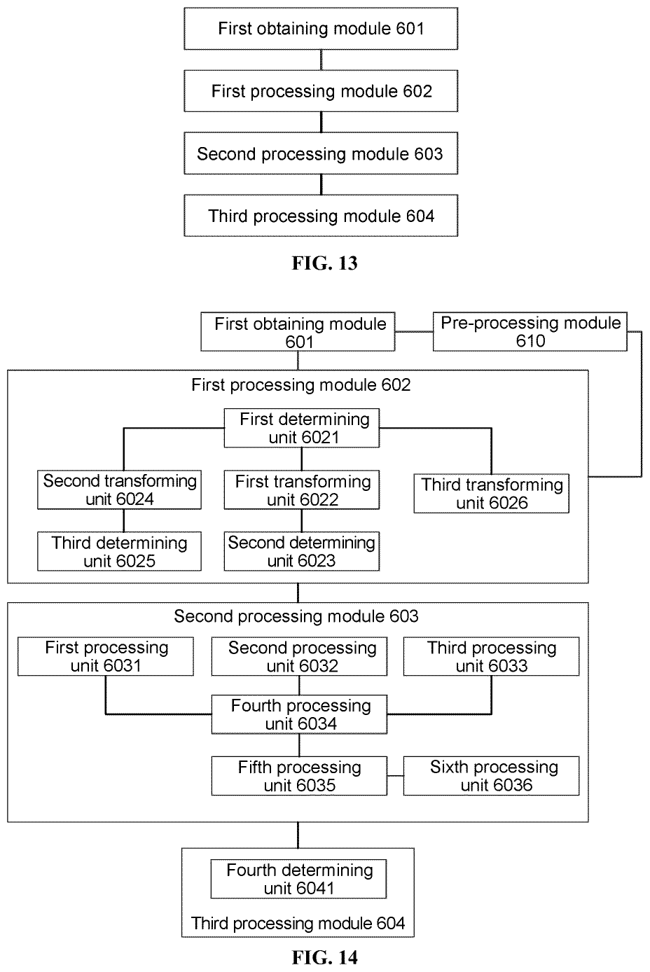

FIG. 13 is a diagram of a structure of an apparatus for determining a perception result state of an object according to an illustrative embodiment of this disclosure. The apparatus according to the embodiment may be configured for implementing the respective embodiment of the method for determining a perception result state of an object according to this disclosure. The apparatus shown in FIG. 13 may include a first obtaining module 601, a first processing module 602, a second processing module 603, and a third processing module 604.

The first obtaining module 601 may be configured for obtaining a respective perception result of at least one time frame and map element information, the respective perception result including state information of at least one object in a first coordinate system.

The first processing module 602 may be configured for determining, based on the respective perception result of the at least one time frame, first trajectory information corresponding to a target object of the at least one object, and second trajectory information of at least one second object around the target object.

The second processing module 603 may be configured for determining a detection result corresponding to the target object based on the first trajectory information, the second trajectory information, and the map element information using a trained perception result state detection model.

The third processing module 604 may be configured for determining a perception result state of the target object based on the detection result.

FIG. 14 is a diagram of a structure of an apparatus for determining a perception result state of an object according to another illustrative embodiment of this disclosure.

In an optional embodiment, the at least one time frame includes a current time frame and at least one historical time frame, and the state information includes a position and heading of the at least one object; the first processing module 602 may include a first determining unit 6021, a first transforming unit 6022, and a second determining unit 6023.

The first determining unit 6021 may be configured for determining, based on a position and heading of the target object corresponding to the current time frame, a target coordinate system taking the target object as an origin.

The first transforming unit 6022 may be configured for transforming state information of the target object corresponding to any one of the at least one historical time frame to the target coordinate system based on a transformation relation between the first coordinate system and the target coordinate system, to obtain first state information in the target coordinate system corresponding to the any one of the at least one historical time frame.

The second determining unit 6023 may be configured for determining, based on first state information corresponding respectively to the at least one historical time frame and origin state information corresponding to the current time frame, the first trajectory information corresponding to the target object, the origin state information being first state information of the target object in the target coordinate system.

In an optional embodiment, the first processing module 602 may further include a second transforming unit 6024 and a third determining unit 6025.

The second transforming unit 6024 may be configured for transforming state information of the at least one second object corresponding to any one of the at least one time frame to the target coordinate system based on the transformation relation between the first coordinate system and the target coordinate system, to obtain second state information of the at least one second object corresponding to the any one of the at least one time frame.

The third determining unit 6025 may be configured for determining second trajectory information corresponding to any one of the at least one second object based on second state information of the second object corresponding respectively to the at least one time frame.

In an optional embodiment, the first processing module 602 may further include a third transforming unit 6026, which may be configured for transforming the map element information to the target coordinate system based on a transformation relation between a map coordinate system corresponding to the map element information and the target coordinate system, to obtain target map element information.

The second processing module 603 may specifically be configured for determining the detection result corresponding to the target object based on the first trajectory information, the second trajectory information, and the target map element information using the trained perception result state detection model.

In an optional embodiment, the second processing module 603 may include a first processing unit 6031, a second processing unit 6032, a third processing unit 6033, a fourth processing unit 6034, a fifth processing unit 6035, and a sixth processing unit 6036.

The first processing unit 6031 may be configured for performing feature extraction on the first trajectory information using a first feature extraction network in the perception result state detection model, to obtain a first feature.

The second processing unit 6032 may be configured for performing feature extraction on the second trajectory information using a second feature extraction network in the perception result state detection model, to obtain a second feature corresponding to the second trajectory information.

The third processing unit 6033 may be configured for performing feature extraction on the map element information using a third feature extraction network in the perception result state detection model, to obtain a static feature.

The fourth processing unit 6034 may be configured for processing the first feature, the second feature, and the static feature using an attention network in the perception result state detection model, to obtain an attention result.

The fifth processing unit 6035 may be configured for processing the attention result using a feature fusion network in the perception result state detection model, to obtain a fusion feature.

The sixth processing unit 6036 may be configured for processing the fusion feature using a detection head network in the perception result state detection model, to obtain the detection result corresponding to the target object.

In an optional embodiment, the detection result may include at least one of a first probability that the perception result state of the target object is a first state and a second probability that the perception result state of the target object is a second state; and the third processing module 604 may include a fourth determining unit 6041, which may be configured for determining the perception result state of the target object based on the at least one of the first probability and the second probability and a probability threshold corresponding to the at least one of the first probability and the second probability.

In an optional embodiment, the apparatus according to embodiments of this disclosure may further include a pre-processing module 610, which may be configured for identifying, based on a preset rule for identification, the at least one object in the respective perception result of the at least one time frame, and determining that a perception result state of a first object meeting the preset rule for identification is an abnormal state; and removing the first object from the respective perception result of the at least one time frame, to obtain a filtered perception result.

The first processing module 602 may specifically be configured for determining, based on the filtered perception result corresponding to the at least one time frame, the first trajectory information corresponding to the target object of the at least one object, and the second trajectory information of the at least one second object around the target object.

Respective embodiments or optional examples of this disclosure may be implemented separately, or in any combination as long as it causes no conflict, specifics of which may be set as needed, and are not limited in embodiments of this disclosure.

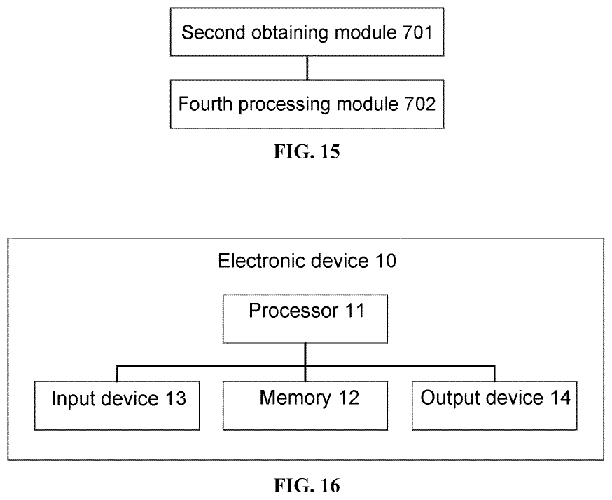

FIG. 15 is a diagram of a structure of an apparatus for training a perception result state detection model according to an illustrative embodiment of this disclosure. The apparatus according to the embodiment may be configured for implementing the respective embodiment of the method for training a perception result state detection model in this disclosure. The apparatus shown in FIG. 15 may include a second obtaining module 701 and a fourth processing module 702.

The second obtaining module 701 may be configured for obtaining first training trajectory information corresponding to a respective training target object in at least one training target object, second training trajectory information of at least one second training object around the respective training target object, and map element information corresponding to the respective training target object.

The fourth processing module 702 may be configured for training a pre-established perception result state detection network based on the first training trajectory information, the second training trajectory information, and the map element information, to obtain a trained perception result state detection model.

In an optional embodiment, the second obtaining module 701 may specifically be configured for: obtaining a respective perception result of at least one time frame, the respective perception result including state information of at least one object in a first coordinate system; setting any one of the at least one time frame to be a current time frame, and determining a first perception result state corresponding to any one object in the current time frame based on state information of the any one object corresponding respectively to the current time frame and a previous time frame, and on a preset rule for identification; in response to the first perception result state corresponding to the any one object being a first state, setting the any one object to be a training target object; determining first training trajectory information corresponding to the training target object based on the state information of the training target object corresponding respectively to the current time frame and the previous time frame; setting a second object around the training target object in the current time frame and the previous time frame to be a second training object; and determining respective second training trajectory information of the at least one second training object based on state information of the at least one second training object corresponding to the current time frame and the previous time frame.

In an optional embodiment, the second obtaining module 701 may further be configured for: determining a second perception result state of the training target object corresponding to a subsequent time frame; determining, based on the second perception result state, a state label for the training target object; and determining the state label data based on a respective state label for the at least one training target object.

The fourth processing module 702 may specifically be configured for: training a pre-established perception result state detection network based on the first training trajectory information, the second training trajectory information, the map element information, and the state label data, to obtain the trained perception result state detection model.

In an optional embodiment, the second obtaining module 701 may further be configured for: determining a trajectory label for the training target object based on the second perception result state and respective state information of the training target object corresponding to the subsequent time frame; and determining the trajectory label data based on a respective trajectory label for the at least one training target object.

The fourth processing module 702 may specifically be configured for: performing joint training on a pre-established joint task network including a perception result state detection network and a trajectory prediction head network based on the first training trajectory information, the second training trajectory information, the map element information, the state label data, and the trajectory label data, to obtain a trained perception result state detection model.

In an optional embodiment, the fourth processing module 702 may specifically be configured for: determining a joint task network based on the perception result state detection network and a trajectory prediction head network; determining a training state detection result and a training trajectory prediction result based on the first training trajectory information, the second training trajectory information, and the map element information using the joint task network; determining a first loss based on the training state detection result and corresponding state label data; determining a second loss based on the training trajectory prediction result and trajectory label data; determining a combined loss based on the first loss and the second loss; in response to the combined loss not meeting a condition for stopping training, updating the joint task network based on the combined loss, to obtain an updated joint task network; setting the updated joint task network to be the joint task network, and repeating the determining a training state detection result and a training trajectory prediction result based on the first training trajectory information, the second training trajectory information, and the map element information using the joint task network; in response to the combined loss meeting the condition for stopping training, obtaining a trained joint task model; and setting a perception result state detection network part in the joint task model to be the perception result state detection model.

Respective embodiments or optional examples of this disclosure may be implemented separately, or in any combination as long as it causes no conflict, specifics of which may be set as needed, and are not limited in embodiments of this disclosure.

For beneficial technical effects corresponding to the illustrative embodiments of this apparatus, one may refer to the respective beneficial technical effects in the “Illustrative method” section described above, which are not repeated here.

### Illustrative Electronic Device

FIG. 16 is a diagram of a structure of an electronic device according to embodiments of this disclosure, where the electronic device includes at least a processor 11 and a memory 12.

The processor 11 may be a central processing unit (CPU) or another form of processing unit having a data processing capability and/or an instruction execution capability, and may control other components in the electronic device 10 to implement desired functions.

The memory 12 may include one or more computer program products, which may include various forms of computer readable storage media, such as a volatile memory and/or a non-volatile memory. The volatile memory may include, for example, random access memory (RAM) and/or cache. The nonvolatile memory may include, for example, read-only memory (ROM), hard disk, flash memory, etc. One or more computer program instructions may be stored on the computer readable storage medium. The processor 11 may execute one or more of the program instructions to implement the method according to the various embodiments of this disclosure that are described above and/or other desired functions.

In an example, the electronic device 10 may further include an input device 13 and an output device 14. These components are connected to each other through a bus system and/or another form of connection mechanism (not shown).

The input device 13 may further include, for example, a keyboard, a mouse, etc.

The output device 14 may output various information to the outside, and may include, for example, a display, a speaker, a printer, a communication network, and a remote output device connected to the communication network, etc.

Of course, for simplicity, FIG. 16 shows only some of components in the electronic device 10 that are related to this disclosure, and components such as a bus, an input/output interface, etc., are omitted. In addition, according to specific application situations, the electronic device 10 may further include any other appropriate components.

### Illustrative Computer Program Product and Computer Readable Storage Medium

In addition to the foregoing method and device, embodiments of this disclosure may also relate to a computer program product, which includes computer program instructions. When the instructions are run by a processor, the processor is enabled to perform the steps, of the method according to the embodiments of this disclosure, that are described in the “Illustrative method” section of this specification.

The computer program product may be program code, written with one or any combination of a plurality of programming languages, that is configured to perform the operations in the embodiments of this disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of this disclosure may further relate to a computer readable storage medium, which stores computer program instructions. When the computer program instructions are run by the processor, the processor is enabled to perform the steps, of the method according to the embodiments of this disclosure, that are described in the “Illustrative method” section of this specification.

The computer readable storage medium may be one readable medium or any combination of a plurality of readable media. The readable medium may be a readable signal medium or a readable storage medium. The readable storage medium may include, for example but is not limited to electricity, magnetism, light, electromagnetism, infrared ray, or a semiconductor system, an apparatus, or a device, or any combination of the above. More specific examples (a non-exhaustive list) of the readable storage medium include: an electrical connection having one or more conducting wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above.

Basic principles of this disclosure are described above in combination with specific embodiments. However, advantages, superiorities, effects, etc., mentioned in this disclosure are merely examples but are not for limitation, and it cannot be considered that these advantages, superiorities, effects, etc., are necessary for each embodiment of this disclosure. Specific details described above are merely for examples and for ease of understanding, rather than limitations. The details described above do not limit that this disclosure must be implemented by using the foregoing specific details.

A person skilled in the art may make various modifications and variations to this disclosure without departing from the spirit and the scope of this application. In this way, if these modifications and variations of this application fall within the scope of the claims and equivalent technologies of the claims of this disclosure, this disclosure also intends to include these modifications and variations.

1. A method for determining a perception result state of an object, including:
obtaining a respective perception result of at least one time frame and map element information, the respective perception result including state information of at least one object in a first coordinate system;
determining, based on the respective perception result of the at least one time frame, first trajectory information corresponding to a target object of the at least one object, and second trajectory information of at least one second object around the target object;
determining a detection result corresponding to the target object based on the first trajectory information, the second trajectory information, and the map element information using a trained perception result state detection model; and
determining a perception result state of the target object based on the detection result.

2. The method of claim 1, wherein the determining a detection result corresponding to the target object based on the first trajectory information, the second trajectory information, and the map element information using a trained perception result state detection model includes:
performing feature extraction on the first trajectory information using a first feature extraction network in the perception result state detection model, to obtain a first feature;
performing feature extraction on the second trajectory information using a second feature extraction network in the perception result state detection model, to obtain a second feature corresponding to the second trajectory information;
performing feature extraction on the map element information using a third feature extraction network in the perception result state detection model, to obtain a static feature;
processing the first feature, the second feature, and the static feature using an attention network in the perception result state detection model, to obtain an attention result;
processing the attention result using a feature fusion network in the perception result state detection model, to obtain a fusion feature; and
processing the fusion feature using a detection head network in the perception result state detection model, to obtain the detection result corresponding to the target object.

3. The method of claim 1, wherein the at least one time frame includes a current time frame and at least one historical time frame, and the state information includes a position and heading of the at least one object, and
the determining, based on the respective perception result of the at least one time frame, first trajectory information corresponding to a target object of the at least one object includes:
determining, based on a position and heading of the target object corresponding to the current time frame, a target coordinate system taking the target object as an origin;
transforming state information of the target object corresponding to any one of the at least one historical time frame to the target coordinate system based on a transformation relation between the first coordinate system and the target coordinate system, to obtain first state information in the target coordinate system corresponding to the any one of the at least one historical time frame; and
determining, based on first state information corresponding respectively to the at least one historical time frame and origin state information corresponding to the current time frame, the first trajectory information corresponding to the target object, the origin state information being first state information of the target object in the target coordinate system.

4. The method of claim 3, wherein the determining, based on the respective perception result of the at least one time frame, the second trajectory information of the at least one second object around the target object includes:
transforming state information of the at least one second object corresponding to any one of the at least one time frame to the target coordinate system based on the transformation relation between the first coordinate system and the target coordinate system, to obtain second state information of the at least one second object corresponding to the any one of the at least one time frame; and
determining second trajectory information corresponding to any one of the at least one second object based on second state information of the second object corresponding respectively to the at least one time frame.

5. The method of claim 3, further including:
transforming the map element information to the target coordinate system based on a transformation relation between a map coordinate system corresponding to the map element information and the target coordinate system, to obtain target map element information, wherein
the determining a detection result corresponding to the target object based on the first trajectory information, the second trajectory information, and the map element information using a trained perception result state detection model includes:
determining the detection result corresponding to the target object based on the first trajectory information, the second trajectory information, and the target map element information using the trained perception result state detection model.

6. The method of claim 1, wherein the
detection result includes at least one of a first probability that the perception result state of the target object is a first state and a second probability that the perception result state of the target object is a second state; and
the determining a perception result state of the target object based on the detection result includes:
determining the perception result state of the target object based on the at least one of the first probability and the second probability and a probability threshold corresponding to the at least one of the first probability and the second probability.

7. The method of claim 1, further including:
identifying, based on a preset rule for identification, the at least one object in the respective perception result of the at least one time frame, and determining that a perception result state of a first object meeting the preset rule for identification is an abnormal state; and
removing the first object from the respective perception result of the at least one time frame, to obtain a filtered perception result, wherein
the determining, based on the respective perception result of the at least one time frame, first trajectory information corresponding to a target object of the at least one object, and second trajectory information of at least one second object around the target object includes:
determining, based on the filtered perception result corresponding to the at least one time frame, the first trajectory information corresponding to the target object of the at least one object, and the second trajectory information of the at least one second object around the target object.

8. A method for training a perception result state detection model, including:
obtaining first training trajectory information corresponding to a respective training target object in at least one training target object, second training trajectory information of at least one second training object around the respective training target object, and map element information corresponding to the respective training target object; and
training a pre-established perception result state detection network based on the first training trajectory information, the second training trajectory information, and the map element information, to obtain a trained perception result state detection model.

9. The method of claim 8, wherein the training a pre-established perception result state detection network based on the first training trajectory information, the second training trajectory information, and the map element information, to obtain a trained perception result state detection model includes:
determining a joint task network based on the perception result state detection network and a trajectory prediction head network;
determining a training state detection result and a training trajectory prediction result based on the first training trajectory information, the second training trajectory information, and the map element information using the joint task network;
determining a first loss based on the training state detection result and corresponding state label data;
determining a second loss based on the training trajectory prediction result and trajectory label data;
determining a combined loss based on the first loss and the second loss;
in response to the combined loss not meeting a condition for stopping training, updating the joint task network based on the combined loss, to obtain an updated joint task network;
setting the updated joint task network to be the joint task network, and repeating the determining a training state detection result and a training trajectory prediction result based on the first training trajectory information, the second training trajectory information, and the map element information using the joint task network;
in response to the combined loss meeting the condition for stopping training, obtaining a trained joint task model; and
setting a perception result state detection network part in the joint task model to be the perception result state detection model.

10. The method of claim 9, wherein the obtaining first training trajectory information corresponding to a respective training target object in at least one training target object, second training trajectory information of at least one second training object around the respective training target object includes:
obtaining a respective perception result of at least one time frame, the respective perception result including state information of at least one object in a first coordinate system;
setting any one of the at least one time frame to be a current time frame, and determining a first perception result state corresponding to any one object in the current time frame based on state information of the any one object corresponding respectively to the current time frame and a previous time frame, and on a preset rule for identification;
in response to the first perception result state corresponding to the any one object being a first state, setting the any one object to be a training target object;
determining first training trajectory information corresponding to the training target object based on the state information of the training target object corresponding respectively to the current time frame and the previous time frame;
setting a second object around the training target object in the current time frame and the previous time frame to be a second training object; and
determining respective second training trajectory information of the at least one second training object based on state information of the at least one second training object corresponding to the current time frame and the previous time frame.

11. The method of claim 10, further including:
determining a second perception result state of the training target object corresponding to a subsequent time frame;
determining, based on the second perception result state, a state label for the training target object;
determining the state label data based on a respective state label for the at least one training target object;
determining a trajectory label for the training target object based on the second perception result state and respective state information of the training target object corresponding to the subsequent time frame; and
determining the trajectory label data based on a respective trajectory label for the at least one training target object.

12. (canceled)

13. (canceled)

14. A non-volatile computer-readable storage medium having a computer program stored thereon, when executed by a processor, the computer program implements the method of claim 1.

15. An electronic device, the electronic device including:
a processor; and
a memory configured for storing a processor-executable instruction, wherein the processor is configured for reading and executing the executable instruction in the memory to implement:
a method for determining a perception result state of an object, including:
obtaining a respective perception result of at least one time frame and map element information, the respective perception result including state information of at least one object in a first coordinate system;
determining, based on the respective perception result of the at least one time frame, first trajectory information corresponding to a target object of the at least one object, and second trajectory information of at least one second object around the target object;
determining a detection result corresponding to the target object based on the first trajectory information, the second trajectory information, and the map element information using a trained perception result state detection model; and
determining a perception result state of the target object based on the detection result; or a method for training a perception result state detection model, including:
obtaining first training trajectory information corresponding to a respective training target object in at least one training target object, second training trajectory information of at least one second training object around the respective training target object, and map element information corresponding to the respective training target object; and
training a pre-established perception result state detection network based on the first training trajectory information, the second training trajectory information, and the map element information, to obtain a trained perception result state detection model.

16. A non-volatile computer-readable storage medium having a computer program stored thereon, when executed by a processor, the computer program implements the method of claim 8.

17. The method of claim 2, wherein the detection result includes at least one of a first probability that the perception result state of the target object is a first state and a second probability that the perception result state of the target object is a second state; and
the determining a perception result state of the target object based on the detection result includes:
determining the perception result state of the target object based on the at least one of the first probability and the second probability and a probability threshold corresponding to the at least one of the first probability and the second probability.

18. The method of claim 3, wherein the detection result includes at least one of a first probability that the perception result state of the target object is a first state and a second probability that the perception result state of the target object is a second state; and
the determining a perception result state of the target object based on the detection result includes:
determining the perception result state of the target object based on the at least one of the first probability and the second probability and a probability threshold corresponding to the at least one of the first probability and the second probability.

19. The method of claim 4, wherein the detection result includes at least one of a first probability that the perception result state of the target object is a first state and a second probability that the perception result state of the target object is a second state; and
the determining a perception result state of the target object based on the detection result includes:
determining the perception result state of the target object based on the at least one of the first probability and the second probability and a probability threshold corresponding to the at least one of the first probability and the second probability.

20. The method of claim 5, wherein the detection result includes at least one of a first probability that the perception result state of the target object is a first state and a second probability that the perception result state of the target object is a second state; and
the determining a perception result state of the target object based on the detection result includes:
determining the perception result state of the target object based on the at least one of the first probability and the second probability and a probability threshold corresponding to the at least one of the first probability and the second probability.

21. The method of claim 2, further including:
identifying, based on a preset rule for identification, the at least one object in the respective perception result of the at least one time frame, and determining that a perception result state of a first object meeting the preset rule for identification is an abnormal state; and
removing the first object from the respective perception result of the at least one time frame, to obtain a filtered perception result, wherein the determining, based on the respective perception result of the at least one time frame, first trajectory information corresponding to a target object of the at least one object, and second trajectory information of at least one second object around the target object includes:
determining, based on the filtered perception result corresponding to the at least one time frame, the first trajectory information corresponding to the target object of the at least one object, and the second trajectory information of the at least one second object around the target object.

22. The method of claim 3, further including:
identifying, based on a preset rule for identification, the at least one object in the respective perception result of the at least one time frame, and determining that a perception result state of a first object meeting the preset rule for identification is an abnormal state; and
removing the first object from the respective perception result of the at least one time frame, to obtain a filtered perception result, wherein the determining, based on the respective perception result of the at least one time frame, first trajectory information corresponding to a target object of the at least one object, and second trajectory information of at least one second object around the target object includes:
determining, based on the filtered perception result corresponding to the at least one time frame, the first trajectory information corresponding to the target object of the at least one object, and the second trajectory information of the at least one second object around the target object.
